(19) United States
(12) Patent Application Publication
(10) Pub. No.: US 2006/0050835 A1
(43) Pub. Date: Mar. 9, 2006

(54) Bi-disperse pebble-bed nuclear reactor

(76) Inventor: Martin Zdenek Bazant, Winchester, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/934,051

(22) Filed: Sep. 3, 2004

(51) Int. Cl. G21C 15/00

(52) U.S. Cl. 376/381

(57) ABSTRACT

A guide ring is positioned in the reactor core vessel of a pebble-bed nuclear reactor to segregate fuel pebbles and reflector pebbles fed into the vessel through respective conduits. The reflector pebbles pass through the guide ring and form a reflector column, while the fuel pebbles pass outside the guide ring and form an annular fuel column surrounding the reflector column. The guide ring controls the size and shape of the reflector column and controls mixing of the two types of pebbles. Furthermore, the fuel pebbles can have a substantially larger diameter than the reflector pebbles. Accordingly, the fuel-pebble column will have more void space, and cooling gas will consequently flow preferentially through the fuel-pebble column.

### RELATED APPLICATION

This application is a continuation-in-part of a prior U.S. patent application, sharing the same title and inventorship as this application and filed on Sep. 1, 2004, the entire teachings of which are incorporated herein by reference.

### BACKGROUND

A major worldwide effort is underway to develop new nuclear power plants for deployment by 2030, following the recommendations of the Generation IV International Forum of ten countries, including the United States. One of the most promising of the six Generation IV reactor concepts, the Very High Temperature Gas-Cooled Reactor (VHTR), is a once-through uranium-based technology using TRISO micro-spheres with helium cooling and graphite moderation, which also provides a possible means of hydrogen production without using fossil fuels or emitting greenhouse gases. In the United States, VHTR is the basis for the Next Generation Nuclear Plant, (NGNP), a Department of Energy project at Idaho National Engineering and Environmental Laboratory (INEEL) scheduled to demonstrate emissions-free, nuclear-assisted hydrogen and electricity production by 2015.

There are two competing VHTR core designs, which have emerged as finalists for the Next Generation Nuclear Plant. The first is the Block Prismatic Reactor, in which the uranium is embedded in a solid graphite core, composed of blocks pre-drilled with holes to allow the passage of helium coolant, as well as control rods. A reactor of this type is currently operating in Japan. A disadvantage of the static block design is that the core must be shut down and reassembled as part of a costly and dangerous refueling process. The static core design also makes it difficult to ensure uniform burn-up and prevents any adjustments to the fuel and moderator distribution during operation, both of which can negatively impact fuel efficiency.

The second VHTR/NGNP design is the Pebble Bed Reactor (PBR), in which the uranium TRISO microspheres are embedded in graphite fuel pebbles, roughly the size of a tennis ball. The fuel pebbles are very slowly cycled through the pebble-bed core, as many as 10-15 times each, which yields rather uniform burn-up and allows continuous operation without the need to shutdown for refueling. PBR was invented by Dr. Rudolf Schulten in the late 1950s, and Germany later successfully operated a pebble-bed reactor for over 20 years.

The PBR concept is currently being revived around the world. China is operating a small pebble-bed reactor (HTR-10), and the South African power utility Eskom is planning large-scale deployment of the Pebble-Bed Modular Reactor (PBMR). In the United States, Massachusetts Institute of Technology (MIT) and INEEL are leading the development of pebble-bed reactor technology with the Modular Pebble-Bed Reactor (MPBR), which may be selected as the design for the Next Generation Nuclear Plant.

Pebble-bed reactors are continuously refueled by slowly cycling radioactive fuel pebbles, which resemble billiard balls, through the reactor core. Altogether, there are about 360,000 pebbles in the core. One pebble is discharged from the bottom of the reactor about every 30 seconds, and an average pebble is cycled through the core 15 times before being discarded. The pebble-bed core is believed to be immune to the “worst-case” nuclear-reactor scenario (i.e., a loss of coolant which would lead to a melting of the uranium fuel and a catastrophic release of radiation). In each fuel pebble, the radioactive material is contained in specially engineered micro-spheres (see below) dispersed in solid graphite, which cannot get hot enough to melt. The graphite encasement should also make the spent fuel pebbles more rugged and resistant to corrosion in long-term storage, which is aided by the lack of radioactive liquid waste, due to the choice of helium gas (rather than water) as a coolant.

In the original German design, all pebbles in the core are identical. A novel feature of MPBR (and an early version of PBMR), however, is the use of two different kinds of pebbles: the usual fuel pebble (i.e., a 60 mm graphite sphere containing, e.g., about 11,000 micro-spheres of coated uranium dioxide, adding up to about 9 g of micro-spheres per pebble) and a pure graphite “reflector pebble” (also known as a “moderator pebble”) of nearly identical size, weight, and surface roughness. The graphite reflector pebbles, like the graphite lining of the reactor, reflect and slow the uranium's neutrons to thereby moderate the neutrons so as to enhance the energy-producing fission process. The reflector pebble need not be pure graphite, but nevertheless is formed mostly of one or more substances of low atomic weight (e.g., beryllium or carbon) that serve to reflect and slow the neutrons with little tendency toward neutron absorption and that do not significantly release neutrons or other nuclear decay products. The reflector pebbles do not include the radioactive micro-spheres and are generally considered non-radioactive; though, at most, free neutrons are generated in the reflector pebbles at a rate decreased several orders of magnitude (e.g., less than 0.01%) from that of the average fuel pebble in the reactor, if free neutrons are generated in the reflector pebbles at all.

Each of the uranium-dioxide micro-spheres in the fuel pebbles is typically about 0.5 mm in diameter and is coated with a layer of porous carbon, a layer of high-density pyrolitic carbon, a layer of silicon carbide, and then another layer of high-density pyrolitic carbon (a composite referred to as “TRISO”). The uranium is in the form of enriched U-235. The silicon carbide layer is sufficiently dense that no radiologically significant quantities of gaseous or metallic fission products are released from the fuel elements at temperatures up to 1,650° C.; this temperature range far exceeds the normal operating temperature (about 1,200° C.) of a reactor and is further believed to exceed the core temperature response that would arise from a loss of forced cooling in the reactor.

To provide a self-sustaining reaction, the uranium of the uranium-oxide is enriched to provide about 8% U-235, which is the isotope of uranium that undergoes the fission reaction. The encapsulation of the uranium-oxide micro-spheres also reduces or eliminates any risk that they might otherwise pose as a resource for weapons proliferation, which is low to begin with due to the relatively low concentration of U-235.

As shown in the left panel of FIG. 1, the reflector pebbles 10 are fed through a drop-hole at the end of a central conduit 12 into a reactor core vessel 14. The central conduit 12 leads to a drop hole at the approximate center of the ceiling 15 of the reactor vessel 14, though the central conduit 12 (or set of such conduits) need not enter the ceiling precisely at the center. The reactor core vessel 14 is a cylinder encased in walls of reflecting graphite blocks. Within the reactor core vessel 14, under normal operating conditions, the reflector pebbles 10 fill a central reflector column 16 on the axis of the reactor core vessel 14, where the reflector pebbles flatten the neutron flux in the center of the core. Meanwhile, fuel pebbles 18 are fed through drop-holes at the ends of a plurality of peripheral conduits 20 passing through the ceiling 15 of the reactor core vessel 14. Within the reactor core vessel 14, under normal operating conditions, the fuel pebbles 18 form an annular fuel column 22 between the column 16 of reflector pebbles 10 and the outer vessel wall.

The pebbles 10, 18 slowly flow downward through the reactor core vessel 14 to the sorter 26 at its exit. The sorter 26 sorts the reflector pebbles 10 from the fuel pebbles 18 as they exit the vessel 14 and typically redirects the pebbles 10, 18 back to the top of the vessel 14 through conduits 12 and 20, e.g., by applying a pressure differential. The sorter 26 further identifies spent fuel pebbles 28, which it removes from circulation, and introduces fresh fuel pebbles 30 to replace the spent fuel pebbles 28. The sorter 26 can sort the pebbles 10, 18 and identify spent fuel pebbles 28 on the basis of any of a variety of properties, such as the temperature and mass of the pebbles or (primarily) from measurements of the amount of radiation emitted from the pebbles.

Within the reactor core vessel 14, the central reflector column 16 and the annular fuel column 22 do not share a distinct boundary as mixing of the reflector pebbles 10 and fuel pebbles 18 occurs in what is referred to as an annular mixed column 24 between the central reflector column 16 and annular outer column 22. The mixed column 24 is not directly controlled. Instead, it arises spontaneously through complicated dynamical processes occurring at the upper surface 34 below the drop holes in the ceiling 15 as well as in the subsurface region 16, 22, 24 of bulk granular flow toward the sorter 26.

The graphite reflector pebbles 10 in the central column 16 help to moderate the nuclear chain reactions in the core vessel 14 by slowing neutrons released from the fuel pebbles 18 and reflecting the neutrons back into the fuel column 22 where the neutrons can cause more fission events and thus sustain the reaction. In this process, the graphite does not itself undergo any nuclear fission reactions; it simply redirects the neutrons and absorbs some of their kinetic energy. The moderating function of the graphite reflector pebbles 10 is also performed by the graphite lining of the fuel pebbles 18 as well as by the graphite blocks that form the outer wall of the core vessel 14.

A special purpose of the central reflector column 16, as a carefully placed moderator, is to flatten the neutron flux profile of the reactor vessel 14. In the MPBR design, the core vessel 14 is roughly 3.5 m in diameter (larger than the German reactor core), and were it filled only with fuel pebbles 18, the central region would experience much larger fluxes than the outer region. This would lead to non-uniform burning and, given the size of the reactor, could make controlling the reaction more difficult. The central reflector column 16 of reflector pebbles 10 thus allows for greater fuel efficiency and more-uniform burning.

In a conventional liquid-cooled reactor, control over the bulk neutron-flux profile can be achieved by inserting graphite rods into the core. In a pebble-bed reactor, however, it is not practical to introduce such rods into the core because the granular material in the core resists penetration like a hard solid, even while it is slowly draining. In the MPBR design, the central column of graphite pebbles 16 thus circumvents this difficulty by mimicking the effect of a solid graphite rod in a conventional liquid-cooled reactor.

Another purpose of the central graphite column is related to safety and control. As in conventional reactors, the power level is adjusted by control rods, which slow and absorb neutrons, typically with boron carbide. Fully inserting the rods allows rapid shutdown, by making the nuclear chain reaction go subcritical. In a pebble-bed reactor, the control rods cannot penetrate the granular-solid pebble bed, so they are inserted into pre-drilled holes in the outer graphite bricks of the core vessel. Another advantage of the central graphite column, therefore, is that the fuel is confined to a more narrow annular region, closer to the control rods in the outer core walls.

In practice, the fuel pebbles and reflector pebbles mix to some degree within the reactor, but a scientific understanding of the statistical dynamics of this kind of granular flow (very slow gravity-driven drainage) is only beginning to be developed. Until recently, no reliable theories existed for answering even some of the simplest questions about this type of drainage. For example, little was known in detail about any of the following phenomena: how the flow rate changes as a function of hole diameter and other geometrical or physical properties of the system; the extent of bulk-particle mixing during granular drainage; whether the mixing is diffusive, and if so, its local diffusion coefficient; and the dependence of mixing on pebble properties, such as the size, shape, mass, and roughness of the pebbles.

During operation of the nuclear reactor, the width of the central graphite column must be carefully determined and controlled. If the column is too wide, then the power output of the reactor is overly reduced. On the other hand, if it is too narrow, the neutron flux distribution is overly non-uniform, leading to inefficient fuel burn-up. Moreover, the peak neutron flux could exceed fuel temperature limits.

In original MPBR and PBMR designs, the relative sizes of the graphite reflector column 16 and the fuel column 22 are determined by the placement (in advance) of different dropping points for pebbles at the top of the core vessel (where the various conduits 12, 20 enter the ceiling 15 of the reactor vessel 14). These dropping points cannot be moved, so the steady-state composition of the core cannot be changed once the reactor is built and in operation. Moreover, it is difficult to accurately predict the precise composition of the core, in particular the structure of the mixed column 24, in advance using only approximate model calculations. The existing designs therefore relied upon approximate model calculations, rather than empirical observation, to optimize the composition, and once the reactor is built, the core composition cannot ordinarily be adjusted to improve power efficiency or to control peak temperatures. This also limits the flexibility to use different types of fuel pebbles because the power distribution cannot be reshaped to conform to new fuel characteristics and limitations, once the reactor is built.

Another important concern with this design is that helium gas passes through a porous graphite column, where it is not directly heated, as it is in the outer fuel annulus. This can compromise thermal efficiency by mixing the hottest helium from the fuel annulus with cooler helium from the graphite column, as the gas passes from the core to the heat exchanger and power generator. If the gas could be focused mostly on the fuel annulus, then the reactor could be operated at higher power (fewer inserted control rods) because heat could be extracted more quickly, while maintaining the appropriate maximum temperature.

### SUMMARY

The above concerns and drawbacks can be addressed by employing a guide ring apparatus and two different sizes of pebbles (a “bi-disperse” core) in the pebble-bed reactors and associated methods, described above.

The difficulty in predicting and controlling the pebble composition of the core is that the distribution of pebbles arises dynamically from the very complicated and poorly understood process of slow granular drainage from a silo. Although some simple and reasonably successful continuum models exist for the mean velocity, there is no mathematical model that correctly predicts velocity fluctuations and pebble mixing in this context.

Experiments now show that remarkably little mixing occurs in the bulk of the reactor core vessel, well below the free surface of the pebble bed and well above the vessel opening where the pebbles drain out of the vessel. The results of these experiments stand in stark contrast to the only previously existing mathematical models of drainage, all based on the idea of “diffusing voids” rising up from the opening.

Current research suggests diffusion occurs by a newly recognized mechanism in which locally correlated pebble motion is caused by the upward diffusion of extended “spots” of slight excess interstitial volume. Experiments have confirmed the basic predictions of the spot model, although much work remains to achieve a complete theory of slow granular flow. In any case, it is becoming clear from this research that bulk mixing in the reactor is small enough to cause pebbles to deviate from the streamlines of the mean flow by at most a few pebble diameters during a passage through the entire core. Similar results have also recently been obtained in experiments on scaled-down models of the reactor core, where it is observed that pebbles in the bulk region deviate very little from the streamlines of the mean flow.

Consequently, the only significant source of mixing is at the free surface of the pebble bed. In the original PBMR/MPBR design (illustrated in FIG. 1) where pebbles are dropped from the ceiling of the core vessel, intermittent avalanches of pebbles 10, 18 cascade down the sides of conical piles to maintain a certain average angle of repose. Avalanches from adjacent piles at the free surface collide and mix the different types of pebbles to produce a diffuse interface 34, which propagates downward with the flow. Simple experiments show that this effect can produce an annular mixed layer of fuel and reflector pebbles 18, 10, which is at least several pebbles wide. This mixed layer near the surface is then translated downward with little additional diffusion, as explained above, thus forming an annular mixed column 24 during the slow drainage flow. Were it not for the surface mixing, however, the interface could in principle be made very sharp, with roughness only at the scale of a single pebble.

This mixing at the free surface can be reduced or eliminated in pebble-bed nuclear reactors, such as those described throughout this disclosure, by a guide ring mounted within the reactor core vessel (as is described in U.S. patent application Ser. No. 10/264,098, the entire teachings of which are incorporated herein by reference). Reflector pebbles are fed through a reflector conduit into the reactor core vessel and through the zone defined by the guide ring. Radioactive fuel pebbles are fed through one or more fuel conduits into the reactor core vessel outside the zone defined by the guide ring.

The guide ring can be substantially cylindrical and should extend down to within at least one or two pebble diameters of the free surface of the pebble bed in the reactor core vessel such that the fuel pebbles and reflector pebbles flow through the reactor in an annular fuel column and in a central reflector column, respectively. Because very little granular mixing occurs beneath the free surface of the pebble bed, the use of the guide ring can provide a distinct boundary between the fuel column and reflector column throughout the reactor core vessel. Further, the cross-sectional area of the guide ring can be adjustable, or a plurality of nested guide rings can be provided to enable dynamic adjustment of the respective cross sections of the two columns (all sections cited herein being measured in a plane perpendicular to the axis of the reactor core vessel). The guide ring can be the only static part in the reactor core (the pebbles not being static).

The adjustable guide ring can essentially eliminate pebble mixing and can give unprecedented control over the core composition (and thus the fuel efficiency, safety, and power output) of a pebble-bed reactor that uses two or more different kinds of pebbles. This guide ring is simple, safe and inexpensive to implement and therefore offers wide applicability in pebble-bed nuclear reactors, particularly in view of the potentially significant benefits in performance, in power variability and in the flexibility of being able to use different types of fuel in the same reactor vessel.

A potential disadvantage of the two-pebble design of MPBR is reduction in thermal efficiency caused by the passage of helium through the porous column of graphite pebbles. Ideally, the helium would flow entirely through the hotter and more radioactive fuel annulus, as in a recently modified PBMR design with a solid central graphite column. Improved helium flow can be achieved using pebbles alone, through a very simple modification, which preserves all of the advantages of MPBR and makes the design even more attractive.

This improvement can be effected by making the graphite moderator/reflector pebbles in the central column smaller than the (standard) fuel pebbles in the outer annulus. The primary advantage of bi-dispersity lies in focusing the helium flow on the fuel column, where it is heated the most, which can dramatically improve thermal efficiency and power capability of the reactor. The latter would result from more-efficient cooling of the fuel region, which could allow the removal of more control rods (greater power), while keeping the core temperature at the target value for safety and optimal fuel performance.

A second advantage of bi-dispersity is the very easy sorting of fuel and graphite pebbles by size alone, upon exit from the core.

### BRIEF DESCRIPTION OF THE DRAWINGS

FIG. 1 is a partially schematic diagram of an existing design for a pebble-bed nuclear reactor, showing different regions of the reactor core, including a mixing column of reflector pebbles and fuel pebbles.

FIG. 2 is a partially schematic diagram of a new design for a pebble-bed nuclear reactor including a guide ring extending slightly below the free surface of the pebble bed in the reactor core vessel; the guide ring suppresses surface mixing in the reactor core vessel, which reduces or eliminates the annular mixed column in the core vessel.

FIG. 3 is a sectional view upward from plane 3-3 of the reactor illustrated in FIG. 2; the sectional view illustrates the output of the conduits through which the pebbles are dropped and the guide ring.

FIG. 4 is a sectional view of an adjustable guide ring.

FIG. 5 is a sectional view of a plurality of nested guide rings.

FIG. 6 is a sectional view of a bi-disperse pebble-bed nuclear reactor core, wherein the graphite pebbles (center are smaller than the surrounding fuel pebbles.

FIG. 7 is a schematic illustration of coolant-gas flow through a standard pebble-bed nuclear reactor with only fuel pebbles, offered for comparison.

FIG. 8 is a schematic illustration of coolant-gas flow through a mono-disperse, two-pebble pebble-bed nuclear reactor with reflector and fuel pebbles of the same size.

FIG. 9 is a schematic illustration of coolant-gas flow through a bi-disperse, two-pebble pebble-bed nuclear reactor, wherein the reflector pebbles are smaller than the fuel pebbles.

FIG. 10 is an illustration, partially schematic, showing the walls of a pebble-bed nuclear reactor and other elements of the gas-flow system.

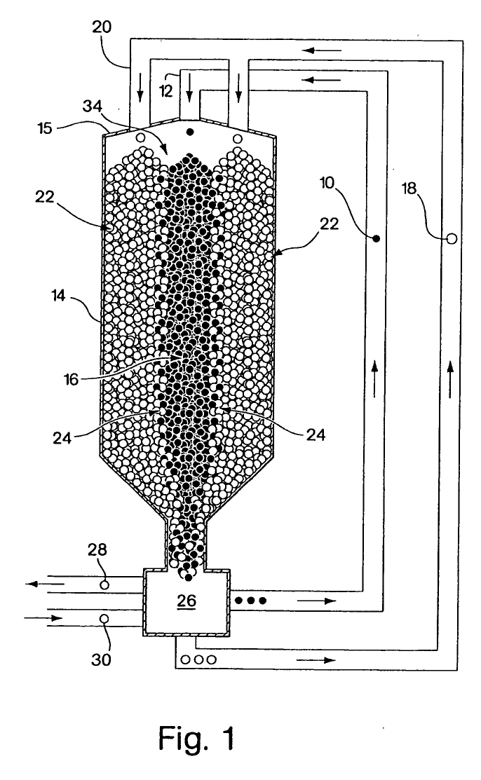

The foregoing and other features and advantages will be apparent from the following, more-particular description. In the accompanying drawings, like reference characters refer to the same or similar parts throughout the different views. The drawings are not necessarily to scale, emphasis instead being placed upon illustrating particular principles, discussed below.

### DETAILED DESCRIPTION

The power system of a modular pebble bed reactor includes a reactor, where thermal energy is generated by a nuclear reaction, and a power conversion unit, where the thermal energy is converted to mechanical work and then to electrical energy by a thermodynamic cycle and a generator. A fluid (particularly a gas, such as helium) is passed through the system, extracting the nuclear-generated heat from the pebble bed and delivering that heat to the power conversion unit, where the gas further serves as the working fluid. Helium is particularly suitable as the heat-transfer medium because of its chemical inertness, its phase stability through normal operating changes in a reactor, and its small nuclear-absorption cross section.

Pebble-Bed Reactor with Guide Ring:

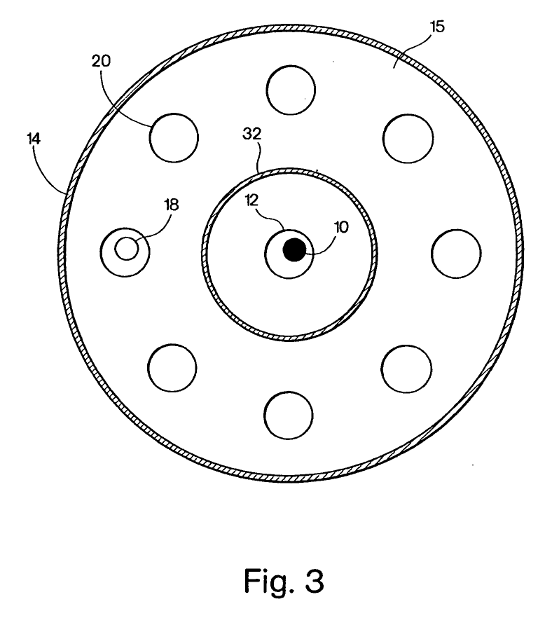

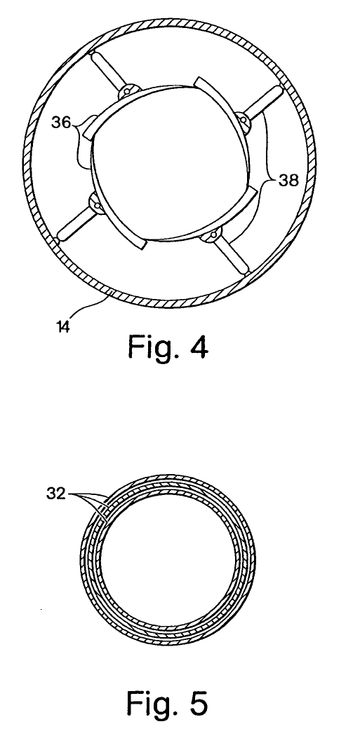

A simple way to prevent the mixing of reflector and fuel pebbles and to precisely control the composition of the core is to add a “guide ring” assembly 32 to the top of the core vessel 14, as shown in FIG. 3. The guide ring 32 can be made of graphite or some other strong, solid, neutron-reflecting material used in other parts of the core, and its inner diameter can be approximately half the diameter of the vessel 14 (e.g., 1.75 m ring inner-diameter for a vessel having an inner diameter of 3.5 m).

The pebbles 10, 18 typically fill 80 to 95% of the core vessel during operation, with the remaining volume being open space above the free surface of the pebble bed. The guide ring 32 extends down to a position near the pebble-bed free surface (may be slightly above or below), so the guide ring 32 will extend away from the ceiling 15 into the core vessel 14 a distance of about 5% to about 20% of the height of the core vessel 14. The remaining 80-95% of the core vessel 14 (below the guide ring) is undivided volume for containing the pebbles 10, 18 without any physical separators for segregating the fuel pebbles 18 from the reflector pebbles 10. In absolute terms, the height of the guide ring 32 (measured along the axis of the cylinder) can be about 50 to about 250 cm.

In one embodiment, the guide ring 32 extends down from the ceiling to a position that is, on average, 2-10 pebbles below the evolving free surface on either side (during steady state cycling of the core), although this depth allowance may need to be increased to accommodate larger fluctuations in surface height. However, the guide ring 32 need not penetrate the free surface and can, in fact, extend down only to a height one to two pebble diameters above the free surface. Fluctuations in the height of the free surface due to avalanches can be reduced by using more drop holes per unit area of the ceiling, which leads to smaller conical piles and thus smaller avalanche events. Fluctuations in height can also arise from statistical variations in the arrival of different types of pebbles from the sorter. During steady operation, this effect will only cause minor perturbations to the surface height (of the order of a few pebble diameters), since pebbles arrive at the sorter already in the right proportion. Care should be taken, however, to properly adjust the ratio of incoming fuel and reflector pebbles to maintain roughly the same free surface heights when the guide ring width is adjusted.

Alternatively, the guide ring 32 need not extend directly from the ceiling 15, though the guide ring 32 preferably extends a sufficient height above the surface of the pebbles 10, 18 to ensure that no pebbles 10, 18 can bounce over the guide ring 32. This height can be determined by assuming that the pebbles on the surface behave as an inelastic solid floor that absorbs some fraction of the kinetic energy when a collision occurs. However, to be sure that no pebbles cross the regions separated by the guide ring, it may be preferable for the guide ring to extend directly from the ceiling. Another reason for the guide-ring shell to extend into the ceiling is that the alternative of suspending the ring from a position below the ceiling introduces additional structural parts which may interfere with the granular flow or may increase the risk of a mechanical failure or fracture of these parts.

The guide ring 32 in this embodiment is cylindrical and is aligned with the axis of the core vessel 14, though other cross-sectional shapes and alignments for the guide ring 32 can be utilized.

The guide ring 32 completely blocks avalanches of different kinds of pebbles 10, 18 from mixing at the free surface, but otherwise does not interfere with the bulk granular flow. Pebbles 10, 18 tumbling down the free surface in avalanches settle into randomly packed positions against the wall of the guide ring 32, where they slowly sink into the core as the pebbles drain from the bottom of the core vessel 14. Once the pebbles 10, 18 pass the lower edge of the ring 32, the fuel pebbles 18 that are at the inner edge of the outer annular column 22 directly contact the reflector pebbles 10 that are at the outer edge of the central reflector column 16 without any physical barrier therebetween. Nevertheless, a sharp interface (i.e., little or no mixing or crossover of pebbles) exists between the columns 16, 20. Experiments suggest that the moving interface will have roughness only at the scale of a single pebble, until it converges very close to the lower opening leading to the sorter 26.

In the simplest guide-ring design, a single ring is fixed in place at a position determined in advance by core-physics calculations. Likewise, with the existing PBMR/MBPR design, the core composition is determined by drop-holes at fixed positions that typically cannot be practically changed after the reactor is built. A fixed-guide ring, however, would still have the desirable effect of eliminating the mixed column 24. In alternative embodiments, the reflector column 16 is not precisely at the center of the core vessel 14, and there may even be a plurality of reflector columns 16, each at a different position, within the core vessel 14. In these embodiments, a guide ring is provided for each reflector column to reduce or prevent intermixing of the reflector pebbles with the surrounding fuel pebbles.

One configuration of drop holes that can be used in the reactor is illustrated in FIG. 3. This configuration includes one centered conduit 12 through which reflector pebbles 10 are fed and eight peripheral conduits 20 through which fuel pebbles 18 are fed from the ceiling 15 of the core vessel 14. The eight conduits 20 for the fuel pebbles 18 are evenly distributed around the periphery of the core. Though, of course, the number and particular positioning of the conduits can be varied. Where a plurality of reflector columns are formed in the pebble bed, corresponding conduits for supplying reflector pebbles are positioned above respective guide rings for each of the columns.

The utility of the adjustable guide ring for providing dynamic variation of the core composition is desirable for a number of reasons. First, the adjustability of the guide ring can offer substantial benefits in terms of efficiency and safety. A predetermined fixed design (with or without a guide ring) may not (and generally will not) be configured to set the optimal width of the reflector column from the perspectives of fuel efficiency or safety from power peaking. Since the optimal width of the central column is difficult to predict in advance from mathematical models, it would be preferable to measure fuel efficiency, peak temperatures, or other metrics empirically once the reactor is operating and then adjust the width of the central graphite column as desired until an optimal composition is reached.

Second, the ability to dynamically vary the core composition affords the operator the flexibility to use different types of fuel, with different performance characteristics and limitations. Since the design of fuel pebbles is an area of active research and development, it is likely that a functioning reactor may need to switch its fuel type. Changing the type of fuel also enables one to control the power output of the reactor in response to various economic considerations. With the current PBMR/MPBR design, it may not be possible to adjust the core composition to make optimal use of the new fuel and also to stay within its possibly different design limitations, e.g., maximum allowable temperature. The adjustable guide ring, however, makes it easy to control the width of the inner column, and hence the composition of the reactor core, on the fly during reactor operation by adjusting the width of the guide ring 32.

If the guide ring extends deep into the core, it is not easily moved radially (to directly expand or contract its diameter) because the granular material acts like a hard solid in the bulk packed region. Near the free surface, however, the guide ring can be moved radially without much hindrance by surface pebbles, which are fairly easily displaced. Above the free surface, the guide ring can be moved radially without any trouble. Thus, the guide ring 32, when it extends no more than a few pebble diameters (e.g., no more than 10) into the core, can be widened or constricted if, e.g., it is made of a set of overlapping guide-ring members 36, here in the form of cylindrical arcs, which can be offset relative to one another (via, e.g., a motorized displacement mechanism 38) to provide varying degrees of overlap and to consequently circumscribe a greater or lesser volume. Note that any such motor mechanism may need to be outside the reactor vessel 14 to avoid the risks of operating in a high-temperature, high-radiation environment.

An even-simpler operational approach to changing the guide-ring diameter is to let the core drain briefly without adding any new pebbles until the free surface height drops near or below the bottom of the guide ring 32 and only then change the diameter of the ring 32. This approach, however, may require briefly storing some pebbles 10, 18 arriving at the sorter before sending them back into the vessel, which may be impractical in some contexts.

One possible problem with adjusting the width of a guide ring 32 directly may be that such adjustments could perhaps raise the likelihood of a mechanical failure. In a worst-case scenario, these width adjustments could cause a piece of the guide ring assembly to break off and fall into the core; the broken piece would then have to be detected and removed to avoid clogging the drain leading to the sorter 26. Although this is a remote possibility with proper engineering, it would still be best to minimize the number of free parts in the reactor vessel 14 that could fracture or otherwise interfere with the granular flow as pebbles are cycled through the core.

These problems may be reduced, or perhaps completely avoided, with another simple design, in which there is an assembly of nested, cylindrical, fixed-size guide rings 32, as shown in FIG. 5, rather than a single adjustable ring. Each of the rings 32 can be lowered one at a time into the core vessel 14 from the ceiling of the vessel (by a mechanism outside the shielding inner wall of the vessel) to the prescribed guide-ring height below the free surface of the pebble bed. The rings 32 can be in a variety of sizes having inner diameters ranging from about one-quarter to about three-quarters the inner diameter of the vessel 14.

Replacement, and thus resizing, of the guide ring at the pebble-bed free surface can be performed in several ways. As in the example above, the core can be drained without refilling while one guide ring 32 is raised and another guide ring 32 is lowered, but this interferes with the normal cycling operation and requires a way of storing some pebbles before reintroducing them into the vessel.

A simpler approach would be to switch from one guide ring to a new one of a different size as follows. (1) While the old guide ring is still fixed in its normal operating position, the new ring is lowered from its storage position in the ceiling until it rests under its own weight on the free surface, at some distance above the normal operating depth. (2) The old ring is raised to its storage position in the ceiling, while adjustments are made for pebbles to begin arriving according to the new composition (ratio of fuel to reflector pebbles), consistent with the desired width for the central column set by the new guide ring. (3) The new ring is allowed to slowly sink into the pebble bed under its own weight as the core drains, while new pebbles arriving from the drop holes are blocked from crossing it. (4) The new ring is fixed in place when it sinks to its desired operating height. In this way, the width of the guide ring can be adjusted without interfering with the normal operation of the reactor, aside from any changes needed to modify the ratio of fuel to reflector pebbles in the core vessel.

If the desired change in width of the guide ring is large (a significant percentage of its diameter) and the core composition cannot be quickly modified to the correct ratio of fuel to reflector pebbles, then the method just described may lead to temporary height fluctuations in the region being contracted (either the central graphite column or the outer fuel column), which could conceivably be larger than desired (e.g., to avoid possibly blocking a drop-hole). In that case, very little perturbation of the surface height can be achieved by simply repeating this process for a sequence of closely nested rings, whose diameters may differ by as little as one or two pebble diameters, with concomitant small changes in the fuel to reflector pebble ratio. Since it may also be desirable to make adjustments in composition gradually for other reasons (e.g., to see the effect of the new composition on fuel efficiency), this would most likely be normal operational procedure to change the width of the guide-ring.

Pebble-Bed Reactor Having Bi-Disperse Pebbles:

A new concept for MPBR and related designs is a bi-disperse core in which the two kinds of pebbles, fuel pebbles 18 and graphite moderator/reflector pebbles 10, have different sizes. The reflector pebbles 10 are significantly smaller than the fuel pebbles 18; e.g., the diameter (linear size) of the reflector pebbles 10 can be less than 90% that of the fuel pebbles 18. In particular embodiments, the diameter of the reflector pebbles 10 is at least 20% smaller (e.g., in the range of about 20% to about 50% smaller) than that of the fuel pebbles 18. Furthermore, the linear size ratio of the reflector pebbles 10 to the fuel pebbles 18 is about 1:2. The size ratio of the fuel pebbles 18 and reflector pebbles 10 is an important parameter, the optimal value of which may vary depending on the composition (i.e., the number of reflector pebbles 10 versus the number of fuel pebbles 18) and geometry (i.e., reactor core size and shape).

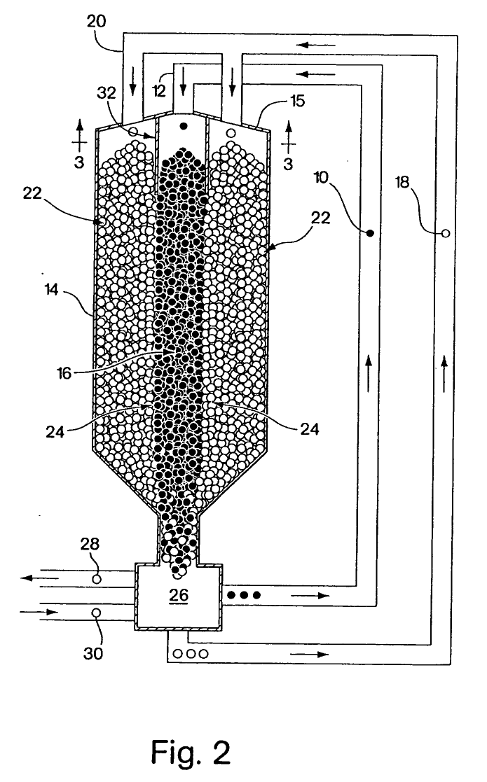

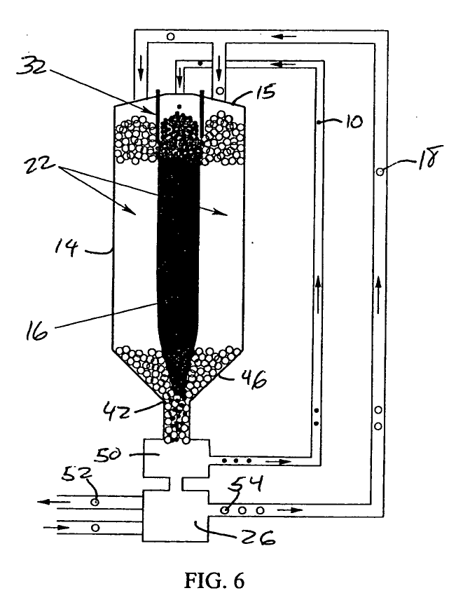

As shown in FIG. 6, the pebble flow and core profile for the bi-disperse MPBR can be very similar to that of the “mono-disperse” MPBR with only one size for graphite and fuel pebbles (as illustrated in FIG. 2). Experiments and simulations at MIT have shown that the degree of bulk mixing during the cycling of a mono-disperse core is very small with pebbles typically deviating from the mean streamlines on the order of one pebble diameter (well below the free surface). For bi-disperse granular materials in many situations, such as rotating drums, vibrated buckets, and draining silos, it is experimentally observed that well-mixed materials have a general (and surprising) tendency to un-mix and separate into mono-disperse regions of large and small grains. As such, we expect no significant mixing between the two regions—the central reflector column 16 and the outer fuel annulus 22—in the bi-disperse core, and the pebble flow should be similar to that of MPBR, except perhaps very close to the orifice 42 at the bottom of the reactor core vessel 14. This is indeed the case in preliminary experiments on bi-disperse reactor models in experiments with glass beads and in full-scale molecular dynamics simulations of the pebble flow.

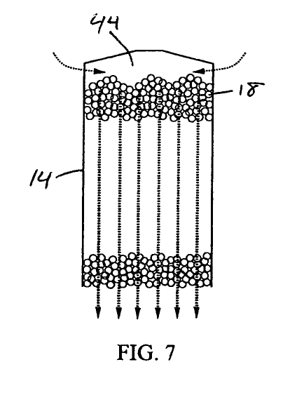

In the MPBR design and others, “cold” (500° C.), high-pressure helium gas is introduced through many small passages in the walls (formed, e.g., of graphite bricks) in the top part of the core vessel, above the upper free surface of the pebble bed. As shown in FIG. 7 (where the gas flow is shown with arrows), the gas quickly equilibrates at a constant pressure in the open region 44 above the pebble-bed and forces a nearly uniform downward gas flow, which is heated along the way, reaching a “very high” outlet temperature (900-950° C.) at the bottom of the pebble bed. In the MPBR, PBMR, and HTR-10 designs, the hot helium gas leaves the core through a large number of small holes drilled in the lower walls, mainly in the funnel region 46.

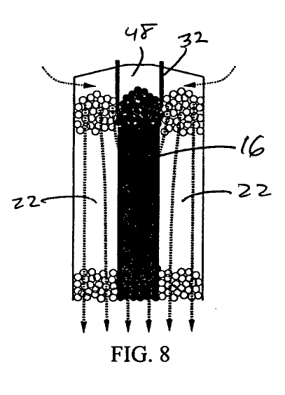

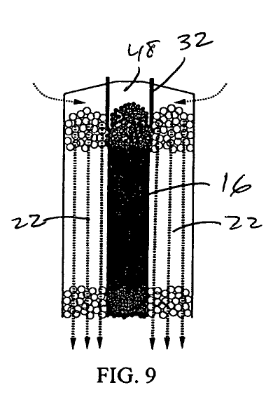

The guide ring 32 in MPBR helps somewhat to concentrate gas flow by creating a stagnant zone 48 above the reflector column 16, forcing the gas flow to enter the column 16 further down in the pebble bed, as shown in FIG. 8. The bi-disperse core (with a guide ring 32), however, causes a much stronger expulsion of gas streamlines from the reflector column 16, thus focusing the gas flow on the hotter fuel column 22 as desired, as shown in FIG. 9.

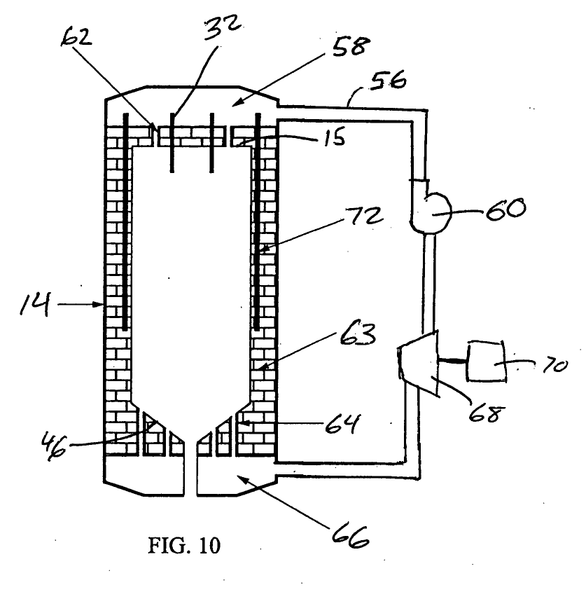

A more-detailed view of the wall structure and apparatus associated with the gas flow in an MPBR having a guide ring is shown in FIG. 10. Cooler, high-pressure helium gas is introduced from conduit 56 into a top chamber 58 of the reactor core vessel 14. The gas is driven through the conduit 56 and through the rest of the system by a pump 60. From the top chamber 58, the gas flows through passages 62 in the graphite bricks 63 through the core ceiling 15 outside the inner volume defined by the guide ring 32. The gas flows through the reactor core, where it extracts heat from the fuel pebbles, and exits from the funnel region 46 through passages 64 into a bottom chamber 66. The hotter, lower-pressure helium gas then exits the bottom chamber 66 and flows through conduit 56 through a turbine 68, which is coupled with a generator 70 for harnessing electricity from the energy of the heated gas. The gas is then pumped back through the reactor core vessel 14 again after cooling and compression. Also shown are control rods 72 inserted through the graphite bricks 63 for controlling the rate of reactions within the core.

This focusing of the gas flow can be easily understood in terms of the classical theory of flow in porous media. The flow of helium gas through the pebble bed should obey Darcy's Law to a good approximation, as for other fluids passing through porous media. Darcy's law states that the mean gas velocity for a given pressure gradient is proportional to the local permeability of the porous medium. For mono-disperse random packings of spheres, the permeability varies as the square of the sphere diameter (or pore size). Therefore, the permeability, and hence the gas flow rate, will be smaller in the more-dense reflector column 16 than in the less-dense fuel annulus 22 by a factor of the square of the size ratio of the two kinds of pebbles 10, 18. For example, with only a factor two reduction in the diameter of the graphite pebbles 16, the permeability of the central reflector column 16 is reduced by a factor of four. This strong sensitivity to the size ratio allows a dramatic reduction in the gas flow through the graphite reflector column 16, instead focusing the helium on the hotter fuel column 22, which is the optimal flow profile. The change in helium-flow distribution is accomplished without significantly changing any other aspects of the pebble-bed core behavior (e.g., pebble flow and core neutronics).

The precise degree of flow focusing depends mainly on geometrical factors, which are easily controlled as part of the reactor design, such as the ratio of radii of the two kinds of pebbles 10 and 18, and the ratio of radii of the two columns (the reflector column 16 and the fuel column 22). The former variable can be easily varied while the reactor is operating. Along with the adjustable guide ring 32, which sets the latter variable, this additional flexibility allows the bi-disperse core to be optimized and controlled during normal operation, in sharp contrast to static core designs (such as the Block Prismatic VHTR). To get a sense for the strong effect of bi-dispersity, note that, in the current MBPR geometry, making the graphite pebbles one-third the size (in diameter) of the fuel pebbles should cause over 90% of the gas flow (by volume) to be focused on the fuel annulus.

The original design of MPBR calls for sorting by radiation detection, which is complicated and not foolproof. On the other hand, robust sorting is well known and could be easily adapted for a bi-disperse pebble-bed reactor. The embodiment of FIG. 6 employs a size sorter 50 to sort the pebbles 10, 18. Of course, a sorter 26 based on radiation detection can still be used for sorting of the fuel pebbles into spent fuel 52 and recyclable fuel 54, as in all pebble-bed reactors.

While this invention has been shown and described with references to particular embodiments thereof, those skilled in the art will understand that various changes in form and details may be made therein without departing from the scope of the invention, which is limited only by the following claims.

1. A pebble-bed nuclear reactor comprising:
a reactor core vessel having input conduits at one end of the vessel through which the fuel pebbles and reflector pebbles can be fed into the vessel and having an output conduit at an opposite end of the vessel through which the fuel pebbles and reflector pebbles can be removed from the vessel, the reactor core vessel defining a passage sized and configured to allow the flow of fuel pebbles and reflector pebbles from the input conduits to the output conduit;
a column of radioactive fuel pebbles containing fissionable radioactive material within the reactor core vessel; and
a column of reflector pebbles that consist essentially of non-fissionable material, and the reflector pebbles having a diameter that is less than 90% of the diameter of the radioactive fuel pebbles,
wherein the column of fuel pebbles (a) includes a free surface below at least a first of the input conduits and (b) extends downward from its free surface beneath the first input conduit toward the output conduit, and
wherein the column of reflector pebbles (a) includes a free surface below at least a second of the input conduits, (b) extends downward from its free surface beneath the second input conduit toward the output conduit, and (c) forms a barrier-free interface with the column of reflector pebbles along a vertical axis through a volume between the input conduits and the output conduit.

2. (canceled)

3. (canceled)

4. The pebble-bed nuclear reactor of claim 1, wherein the reflector pebbles have a diameter that is less than 80% of the diameter of the fuel pebbles.

5. The pebble-bed nuclear reactor of claim 1, wherein the reflector pebbles have a diameter that is between about 50% and about 80% of the diameter of the fuel pebbles.

6. The pebble-bed nuclear reactor of claim 1, wherein the column of radioactive fuel pebbles is less dense than the column of reflector pebbles.

7. The pebble-bed nuclear reactor of claim 1, further comprising at least one gas conduit coupled with the reactor core vessel so as to define a path for gas flow from the gas conduit through the reactor core vessel.

8. The pebble-bed nuclear reactor of claim 1, further comprising a guide ring mounted within the reactor core vessel, the guide ring defining an inner volume within the ring and on outer annular volume outside the guide ring, wherein the column of fuel pebbles extends beneath the outer annular volume defined by the guide ring, and wherein the column of reflector pebbles extends beneath the inner volume defined by the guide ring.

9. The pebble-bed nuclear reactor of claim 1, wherein the radioactive fuel pebbles include micro-spheres of fissionable radioactive material.

10. The pebble-bed nuclear reactor of claim 9, wherein the reflector pebbles are free of micro-spheres of fissionable radioactive material.

11. The pebble-bed nuclear reactor of claim 1, wherein the fissionable radioactive material comprises uranium-235.

12. The pebble-bed nuclear reactor of claim 1, wherein the reflector pebbles consist essentially of graphite.

13. The pebble-bed nuclear reactor of claim 1, wherein the fuel pebbles comprise a sufficient concentration of fissionable, radioactive material to generate and maintain a nuclear chain reaction; while the reflector pebbles do not comprise a sufficient concentration of fissionable, radioactive material to generate and maintain a nuclear chain reaction.

14. (canceled)

15. The pebble-bed nuclear reactor of claim 1, further comprising:
at least one reflector-pebble conduit coupling the output conduit with the second input conduit for recycling the reflector pebbles back into and through the reactor core vessel after the reflector pebbles pass through the output conduit; and
at least one fuel-pebble conduit coupling the output conduit with the first input conduit for recycling the fuel pebbles back into and through the reactor core vessel after the fuel pebbles pass through the output conduit.

16. The pebble-bed nuclear reactor of claim 15, further comprising a sorter coupled with the conduits, the sorter configured to sort the reflector pebbles and the fuel pebbles based on pebble size, to direct the reflector pebbles to the reflector-pebble conduit, and to direct the fuel pebbles to the fuel-pebble conduit.

17. The pebble-bed nuclear reactor of claim 1, further comprising a coolant system comprising:
a conduit coupled with the reactor core vessel such that the conduit can extract gas at one end or pebble columns and reintroduce the gas at an opposite end of the pebble columns; and
a turbine and generator coupled with the conduit for harnessing energy from the gas passing therethrough and converting the energy into an electrical voltage.

18. A method for operating a pebble-bed nuclear reactor comprising:
feeding at least one column of radioactive fuel pebbles containing fissionable radioactive material through a reactor core vessel;
feeding at least one column of reflector pebbles through the reactor core vessel, the reflector pebbles being substantially free of fissionable radioactive material and the reflector-pebble column having substantially less void space between the pebbles through which gas can flow than has the fuel-pebble column, and wherein reflector pebbles at a periphery of the reflector-pebble column contact fuel pebbles at a periphery of the fuel-pebble conduit within the reactor core vessel; and
flowing cooling gas through the reactor core vessel, the cooling gas flowing through the fuel-pebble column at a velocity that is higher than the velocity at which the cooling gas flows through the reflector-pebble column.

19. The method of claim 18, wherein the reflector pebbles have a diameter that is less than about 80% of the diameter of the fuel pebbles.

20. The method of claim 18, wherein the reflector pebbles pass through a guide ring within the reactor core vessel before they join the column of reflector pebbles, and wherein the fuel pebbles pass outside a guide ring before they join the column of guide ring, the guide ring serving to prevent mixing of pebbles at a top surface of the columns.

21. The method of claim 18, wherein heat is extracted from the cooling gas after the cooling gas leaves the reactor core vessel and converted into an electrical voltage.

22. The method of claim 18, wherein the radioactive fuel pebbles include micro-spheres of fissionable radioactive material, while the reflector pebbles are free of such micro-spheres.

23. The method of claim 18, wherein the reflector pebbles consist essentially of graphite.

24. The method of claim 23, wherein the fuel pebbles comprise uranium-235.

25. The method of claim 18, wherein neutrons are released from the fissionable material in the reflector pebbles, and wherein the reflector pebbles moderate the neutrons by reflecting and slowing the neutrons, and wherein a nuclear chain reaction is generated and maintained in the nuclear reactor core via the reflector pebbles' moderation of the neutrons and the collision of the neutrons with the fissionable material to release additional neutrons.

26. The method of claim 18, further comprising;
sorting the reflector pebbles and the fuel pebbles based on size as the pebbles leave the reactor core vessel; and
directing the pebbles through different conduits back into the reactor core vessel based on the sorting.

27. The pebble-bed nuclear reactor of claim 15, further comprising at least one fuel pebble contained in the fuel-pebble conduit.

28. The pebble-bed nuclear reactor of claim 27, further comprising at least one reflector pebble contained in the reflector-pebble conduit

29. The pebble-bed nuclear reactor of claim 15, wherein the fuel-pebble conduit is coupled with a plurality of input conduits above the free surface of the column fuel pebbles.
